(19) United States
(12) Patent Application Publication
(10) Pub. No.: US 2019/0316728 A1
(43) Pub. Date: Oct. 17, 2019

(54) MICROPHONE STAND BOOM LOCK

(71) Applicant: BIGROCK INNOVATIONS LLC, Marina del Rey, CA (US)

(72) Inventors: Allen CHANCE, Los Angeles, CA (US); William GRAY, Los Angeles, CA (US)

(21) Appl. No.: 16/380,835

(22) Filed: Apr. 10, 2019

Related U.S. Application Data
(60) Provisional application No. 62/656,359, filed on Apr. 12, 2018.

(51) Int. Cl. F16M 11/10

(52) U.S. Cl. CPC F16M 11/10; H04R 1/08; F16M 2200/041; F16M 2200/022

(57) ABSTRACT

A lock assembly for a stand assembly having a supporting a boom arm is provided herein. The lock assembly can include a support member defining first and second voids at opposing end portions of thereof. A first locking knob can have a first handle and a first shaft extending from the first handle. A second locking knob can have a second handle and a second shaft extending from the second handle. A first mounting fixture can be configured to at least partially surround the boom arm and defining a first hole. The first shaft can be positioned through the first void and the first hole. A second mounting fixture can be configured to at least partially surround the support and defining a second hole. The second shaft can be positioned through the second void and the second hole.

### CROSS-REFERENCE TO RELATED APPLICATION

This application claims the benefit of U.S. provisional patent application Ser. No. 62/656,359, filed on Apr. 12, 2018, the full disclosure of which is incorporated herein by reference.

### FIELD OF THE INVENTION

The present disclosure generally relates to electronic device stands, and more particularly, to stands capable of holding music equipment.

### BACKGROUND OF THE INVENTION

Various types of stand assemblies are used to maintain various music equipment in static positions while in use. It is desired to design a lock to ensure the stand maintains the music equipment in a predefined position.

### SUMMARY OF THE INVENTION

According to some aspects of the present disclosure, a lock assembly for a stand assembly having a supporting a boom arm is disclosed. The lock assembly includes a support member defining first and second voids at opposing end portions of thereof. A first locking knob has a first handle and a first shaft extends from the first handle. A second locking knob has a second handle and a second shaft extends from the second handle. A first mounting fixture is configured to at least partially surround the boom arm and defines a first hole. The first shaft is positioned through the first void and the first hole. A second mounting fixture is configured to at least partially surround the support and defines a second hole. The second shaft is positioned through the second void and the second hole.

In a further non-limiting embodiment of the foregoing assembly, the first and second shafts each define threaded portions thereon that are configured to interact with threaded portions on the first and second holes. Additionally or alternatively, the lock assembly may include a first tip portion on the first shaft and a second tip portion on the second shaft. The first and second shafts are formed from a first material and the first and second tip portions are formed from a second, different material. In some embodiments, the second material has a higher coefficient of friction than the first material.

In a further non-limiting embodiment of any of the foregoing assemblies, the lock assembly can further include a first insert disposed within the hole of the first mounting fixture.

In a further non-limiting embodiment of any of the foregoing assemblies, the lock assembly can further include a rib extending between the first and second voids of the support member.

In a further non-limiting embodiment of any of the foregoing assemblies, the lock assembly can further include one or more washers positioned around the first shaft on an opposing side of the support member from the first mounting fixture.

In a further non-limiting embodiment of any of the foregoing assemblies, the first handle is over-molded onto the first shaft.

In a further non-limiting embodiment of any of the foregoing assemblies, the boom arm is configured to be compressively retained between a retaining surface of the first mounting fixture and the first shaft.

According to some aspects of the present disclosure, a lock assembly is disclosed that includes a support member defining first and second voids. A first locking knob has a first shaft. A second locking knob has a second shaft. A first mounting fixture defines a first hole and a first retaining pocket. The first retaining pocket is configured to at least partially surround a boom arm. A second mounting fixture defines a second hole and a second retaining pocket. The second retaining pocket is configured to at least partially surround a support.

In a further non-limiting embodiment of the foregoing assembly, the lock assembly includes a first washer positioned around the first shaft; and a second washer positioned around the second shaft.

In a further non-limiting embodiment of any of the foregoing assemblies, the first locking knob further includes a first handle and a first tip portion at opposing ends of the first shaft, the first handle formed from a first material, the first shaft formed from a second material, and the first tip portion formed from a third material.

In a further non-limiting embodiment of any of the foregoing assemblies, the third material is at least partially formed of a nylon material.

In a further non-limiting embodiment of any of the foregoing assemblies, the first mounting fixture defines a first opening and the second mounting fixture defines a second opening, the first opening having a width that is greater than a diameter of the boom arm and the second opening having a width that is greater than a diameter of the support.

In a further non-limiting embodiment of any of the foregoing assemblies, the first and second shafts each define thread portions thereon that are configured to interact with threaded portions on the first and second holes.

In a further non-limiting embodiment of any of the foregoing assemblies, the support is configured to be compressively retained between a retaining surface of the second mounting fixture and the second shaft.

According to some aspects of the present disclosure, a lock assembly is disclosed that includes a support member defining first and second voids. A rib extends from the support member. A first mounting fixture is operably coupled with a first shaft. The first mounting fixture is configured to at least partially surround a boom arm. A second mounting fixture is operably coupled with a second shaft. The second mounting fixture is configured to at least partially surround a support.

In a further non-limiting embodiment of the foregoing assembly, the rib extends between the first and second voids of the support member.

Additionally or alternatively, the first shaft is positioned through the first void and the second shaft is positioned through the second void. Additionally or alternatively, the first and second shafts each include a threaded portion thereon that respectively interact with threaded portions within first and second holes respectively defined by the first and second mounting fixtures.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a side perspective view of a microphone stand assembly having a microphone and a pop filter coupled thereto, according to some examples;

FIG. 2A is a side perspective view of a portion of the stand assembly having a lock assembly coupled to a boom arm and a support of the stand assembly, according to some examples;

FIG. 2B is a side perspective view of a portion of the stand assembly and the lock assembly, according to some examples;

FIG. 3 is a side plan view of the lock assembly retaining a first end portion of the boom arm, which retains the microphone, vertically below an opposing, second end portion of the boom arm, according to some examples;

FIG. 4 is a side plan view of the lock assembly retaining the first and second end portions of the boom arm in a substantially horizontal orientation, according to some examples;

FIG. 5 is a side plan view of the lock assembly retaining the first end portion of the boom vertically above an opposing, second end portion of the boom arm, according to some examples;

FIG. 6 is a side plan view of a support member of the lock assembly, according to some examples;

FIG. 7 is a top plan view of the support member, according to some examples;

FIG. 8 is a side perspective view of the lock assembly, according to some examples;

FIG. 9 is a partially exploded top perspective view of the lock assembly, according to some examples;

FIG. 10A is a side perspective view of a first locking knob having a first handle and a first shaft, according to some examples;

FIG. 10B is a front perspective view of the first locking knob, according to some examples;

FIG. 10C is a top plan view of the first locking knob, according to some examples;

FIG. 11A is a side perspective view of a second locking knob having a second handle and a second shaft, according to some examples;

FIG. 11B is a front perspective view of the second locking knob, according to some examples;

FIG. 11C is a top plan view of the second locking knob, according to some examples;

FIG. 12A is a top plan view of a first mounting fixture that is operably coupled with the first locking knob, according to some examples;

FIG. 12B is a side plan view of the first mounting fixture, according to some examples;

FIG. 13A is a top plan view of a second mounting fixture that is operably coupled with the second locking knob, according to some examples;

FIG. 13B is a side plan view of the second mounting fixture, according to some examples;

FIG. 14 is a bottom perspective view of the first mounting fixture disposed on the boom arm, according to some examples;

FIG. 15 is a side perspective view of the second mounting fixture disposed on the support, according to some examples;

FIG. 16 is a side perspective view of a clamp of the lock assembly having a single washer, according to some examples; and

FIG. 17 is a side perspective view of a clamp of the lock assembly having a pair of washers, according to some examples.

### DETAILED DESCRIPTION OF THE PREFERRED EXAMPLES

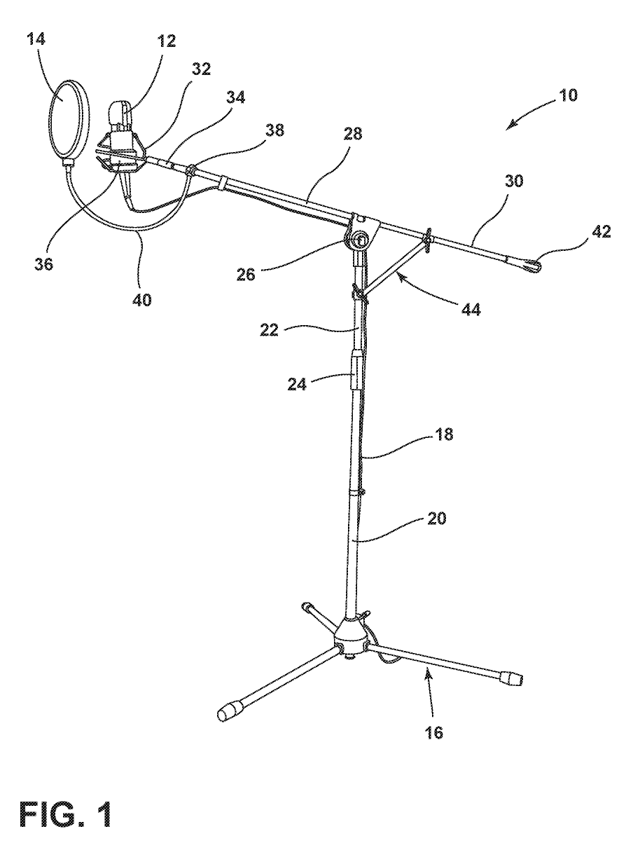

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if any assembly or composition is described as containing components A, B, and/or C, the assembly or composition can contain A alone; B alone; C alone; A and B in combination; A and C in combination; B and C in combination; or A, B, and C in combination.

Boom microphone arms can be used to support a microphone. During operation of the microphone, an operator can either hold a boom microphone arm or use a stand to support the boom arm. If a stand is used to support the boom arm, it is desirable that the microphone remain in a position chosen by the user. When a stand is used for supporting a boom arm, the stand generally includes a base and a vertical stand extending from the base. The boom arm connects with an opposing end of the stand from the base, often, through an upwardly projecting shank portion. In this case, the boom arm carries a clamp for being clamped to the upwardly projecting shank portion of the stand. Regardless of how the boom arm connects to the stand, the vertical stand forms a fulcrum about which the boom arm pivots. By pivoting the boom arm, a user can raise or lower the microphone to a desired position. Once the boom arm is at a user's preferred angle and, thus, the microphone is in a desired position, pivoting of the arm with respect to the stand is no longer desirable, since it is uncontrolled pivoting of the boom arm that can cause the microphone to fall to the ground.

The clamp that is disposed on the upper end of the stand can be used to retain the boom arm in a desired position. When the clamp is loosened, the boom arm is able to pivot about the stand. When the boom arm is pivoted to the desired orientation, the clamp is tightened on the shank. However, vibrations that occur during recording can contribute forces that cause the clamp to gradually loosen to the point of failure, where the microphone will drop down and hit the ground, sustaining damage to the support assembly and/or the microphone. Furthermore, an operator may easily fail to sufficiently tighten the clamp, putting the microphone at risk of falling to the ground. Moreover, over time, the clamp may wear, diminishing its ability to protect the microphone from falling. Despite the presence of the clamp, the microphone may still fall to the ground, sustaining damage, which may cause a recording to be ruined.

The following disclosure describes a lock assembly for a stand assembly having a support supporting a boom arm. The lock assembly can include a support member defining first and second voids at opposing end portions of thereof. A first locking knob can have a first handle and a first shaft extending from the first handle. A second locking knob can have a second handle and a second shaft extending from the second handle. A first mounting fixture can be configured to at least partially surround the boom arm and defining a first hole. The first shaft can be positioned through the first void and the first hole. A second mounting fixture can be configured to at least partially surround the support and defining a second hole. The second shaft can be positioned through the second void and the second hole.

The stand assembly is adapted to support one or more of a variety of known devices thereon. For example, the stand assembly may support microphones, cameras, lights, medical equipment, and many other devices. In the example illustrated in FIG. 1, the stand assembly 10 is configured to support a microphone 12, or other recording device, and a pop filter 14. The pop filter 14 is used between a sound source (e.g., from a person) and a microphone 12 to reduce the effects of “pops” or other similar obtrusive sounds from being recorded. Pops or other obtrusive sounds are generated when vocal sounds (such as for example when the letter “P” or “B” is pronounced) produce air thrust (or blast), resulting in an explosive or “pop” sound. The pop sound within a recording is obviously not usable, and hence, the need for filtering the pop sound for a clean recording.

The stand assembly 10 provided herein may substantially prevent a microphone 12 boom arm from sagging through a quick and simple operation. Moreover, the lock assembly is fully adjustable and can be used on a wide array of microphone 12 stands having various structural configurations. The lock assembly can protect microphones, or any other equipment, that is supported by the microphone stand assembly 10. In addition, by maintaining the microphone 12 in a desired position, the lock assembly can also prevent ruined recording sessions due to movement of the microphone 12, or other electronic equipment.

In the embodiment illustrated in FIG. 1, the stand assembly 10 includes a base 16 which is designed to support the stand assembly 10 upon a floor or other surface. The base 16 may be configured such that various portions of the base 16 may be adjusted to level the assembly. In some examples, the base 16 may be fixed to the floor.

A vertical support 18 extends from the base 16 that can include one or more segments 20, 22 that telescope relative to one another 20, 22 and are locked into place by a locking member 24. At the top of the support 18 distal to base 16 is a pivoting boom support clamp 26, carrying thereon a boom arm 28. The boom arm 28, like the support 18, may include one or more of telescoping sections 30, 32 held in relative placement by additional locking members 34.

A mount 36 may be attached to one end portion 56 of the boom arm that is configured to support the microphone. The pop filter 14, in use, is configured to be positioned between an audio source, e.g., a human singer, announcer, speaker or any other source of audio that may generate plosive artifacts, and the microphone thereby improving the fidelity of the electronic signal output by the microphone 12. In some embodiments, such as the example illustrated in FIG. 1, the pop filter 14 may be secured in the intermediate position through a bracket 38 to secure the pop filter 14 to the boom arm 28. The pop filter may include a gooseneck 10 operably coupled with the bracket 38. In other embodiments, alternative mounts may be used to position pop filter 14. For example, a pop filter may be secured directly to a microphone, secured to a shock mount for the microphone, secured to other structures within a studio, or supported by a separate stand.

A counterweight 42 may be positioned on an opposing end portion 58 of the boom arm 28 from the mount to counteract the weight of the microphone 12 and/or the pop filter 14 such that the rotational forces placed on the support clamp can be reduced. In addition to, or in lieu of the counterweight 42, a lock assembly 44 may be removably coupled with the boom arm 28 and the support 18 to maintain the boom arm 28 in a desired position.

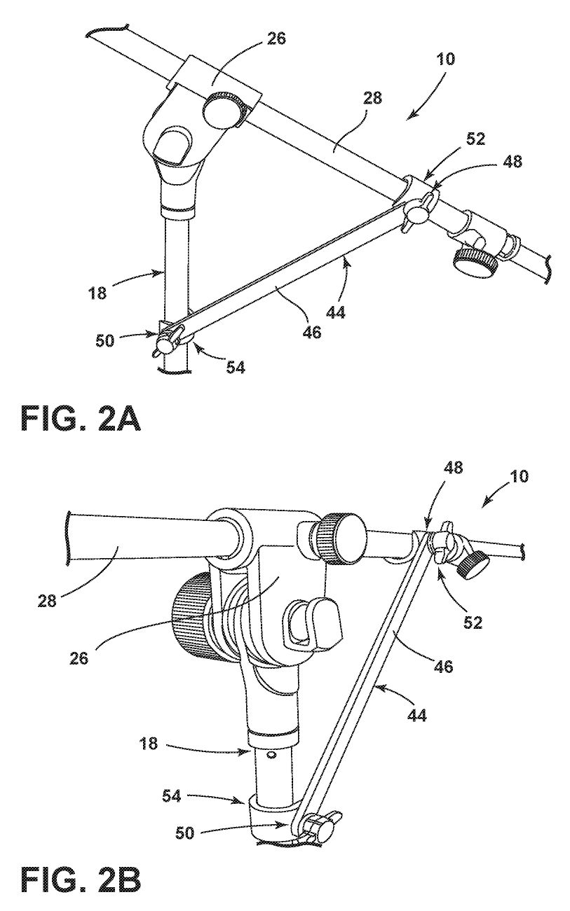

As illustrated in FIGS. 2A and 2B, the lock assembly 44 includes a support member 46 that attaches to the boom arm 28 and the support 18 on two opposing end portions 48. 50. In some examples, the lock assembly 44 includes one or more clamps, such as a boom arm clamp 52 proximate to the first end portion of the support member 46 that may be disposed about at least a portion of the boom arm 28. The boom arm clamp 52 can include a first locking knob 70 and a first mounting fixture 96. Likewise, in some examples, the lock assembly 44 can also include a support clamp 54 proximate to the second end portion of the support member 46 that may be disposed about at least a portion of the support 18. The support clamp 54 can include a second locking knob 72 and a second mounting fixture 98. In some embodiments, the boom arm clamp and/or the support clamp may be replaced with other attachment assemblies. For example, the support member, the support, and/or the boom arm may define a plurality of openings therethrough. A fastener may be inserted through the various openings to lock the support and boom arm in a desired position relative to one another.

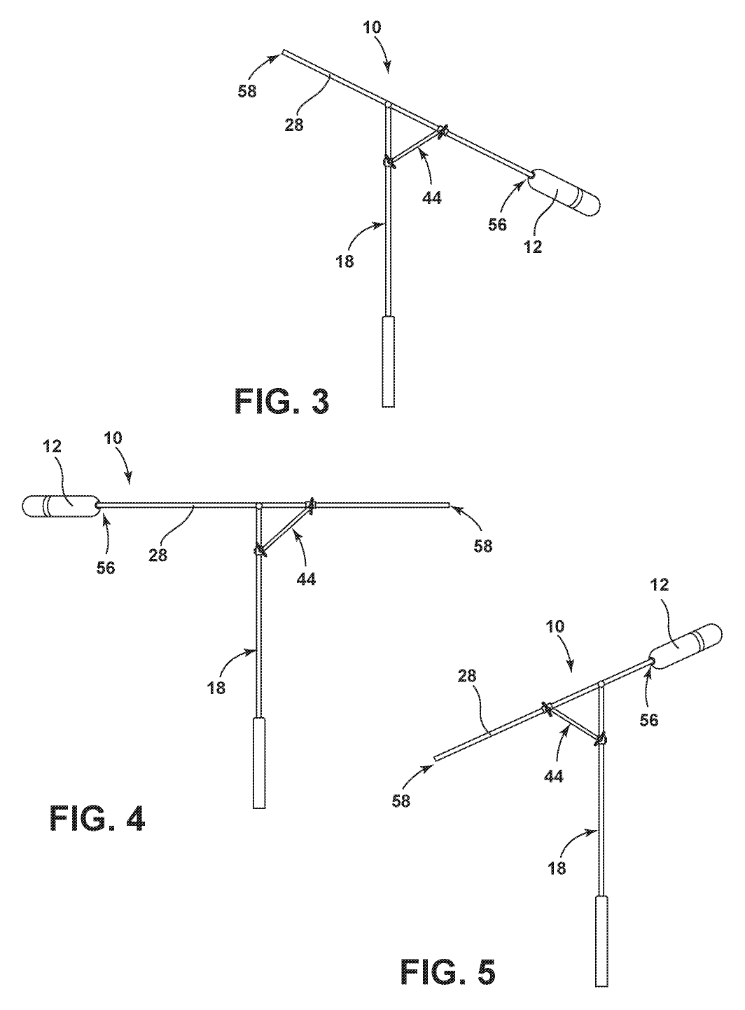

As illustrated in FIGS. 3-5, the lock assembly 44 provided herein may be used to place the boom arm 28 in a wide array of positions. For example, as illustrated in FIG. 3, the boom arm 28 may be orientated such that a first end portion 56 of the boom arm 28, which is configured to support the microphone 12, may be vertically below a second, opposing end portion 58 of the boom arm 28. Additionally, as illustrated in FIG. 4, through use of the lock assembly 44, the first and second end portions 56, 58 may be positioned in a substantially horizontal orientation. As illustrated in FIG. 5, in some examples, the lock assembly 44 may be used to maintain the first end portion 56 in a position that is vertically above the second end portion 58. In various embodiments, the support member 46 is rigid and of a fixed length which allows each of these positions to be obtained. Conversely, other lock assemblies may not be capable of retaining the boom arm in each of these positions relative to the support as the other devices may slide or move causing the boom arm to also move from the desired position.

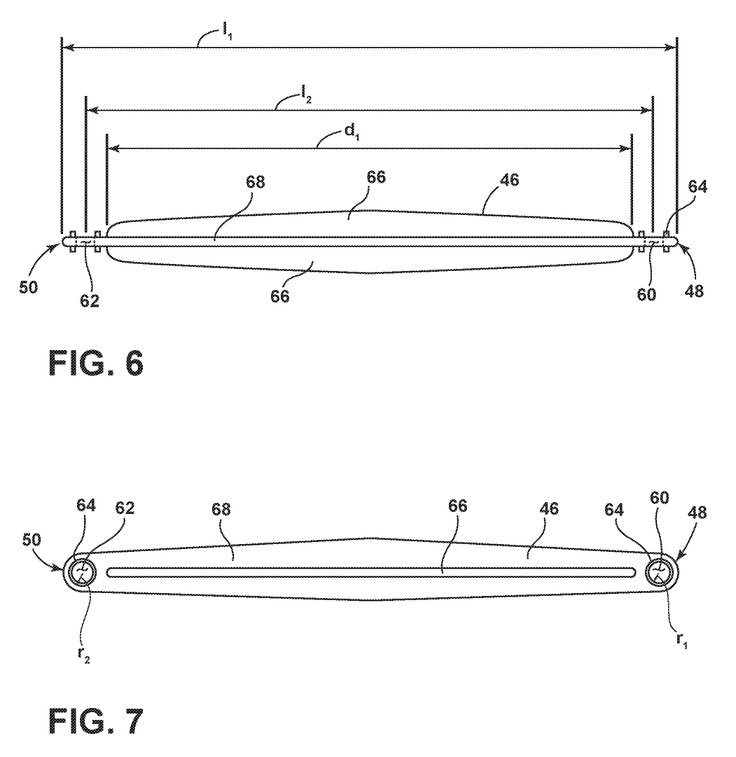

As illustrated in FIGS. 6 and 7, the support member 46 defines first and second voids 60, 62 proximate to respective first and second end portions 48, 50 of the support member 46. The support member 46 may be rigid and, thus, the first and second voids 60, 62 may remain a constant distance di from one another. In some embodiments, however, the support member 46 may be flexible. In such instances, the distance di between the first and second voids 60, 62 may be altered. Moreover, in some embodiments, the support member may include more than first and second voids such that the boom arm lock and/or the support lock may be moved to various positions along the support member.

The first and second voids 60, 62 have respective first and second radii r₁, r₂. The first and second radii r₁, r₂ may be of a common size or varied from one another depending on the embodiment. A collar 64 may be disposed about the rim of each of the first and second voids 60, 62. In some embodiments, the first and second voids 60, 62 and/or the collars 64 may be unthreaded and/or generally smooth. However, in some examples, the first and second voids and/or the collars may include threaded portions or other surface variations.

In some embodiments, such as the example illustrated in FIGS. 6 and 7, a rib 66 may extend from the support member 46. In some examples, a body 68 of the support member 46 is of a first length l₁ and the rib 66 is of a second, shorter length l₂. In addition, in the embodiment illustrated in FIGS. 6 and 7, the first void 60 is disposed outwardly of a first end portion of the rib 66 and the second void 62 is disposed outwardly of an opposing second, end portion of the rib 66. However, the first and second voids 60, 62 may be disposed in any position. As illustrated, the body 68 and the rib 66 may have portions of varied width. For example, the body 68 and/or the rib 66 may have a central portion having a width that is greater than at least one end portion. In various embodiments, the rib may extend from one side of the body in any other manner.

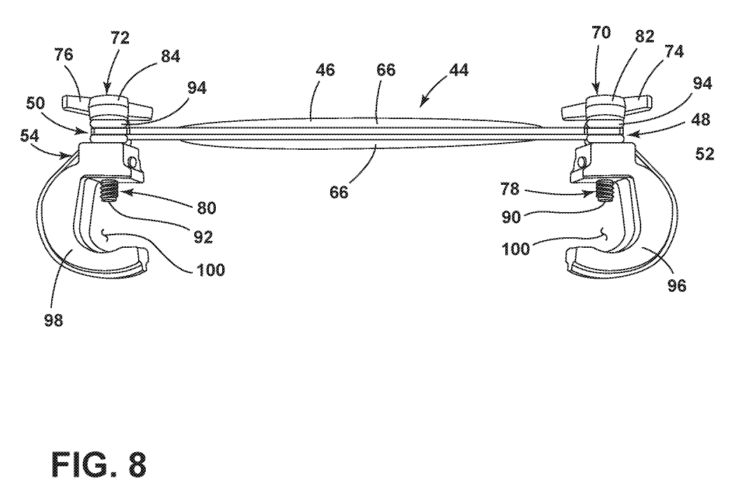

A first locking knob is used in conjunction with the first void and a second locking knob is used in conjunction with the second void. Each of the first and second locking knobs may operably couple with respective first and second mounting fixtures. As illustrated in FIGS. 8-11C, each locking knob 70, 72 includes a respective handle 74, 76 and a respective shaft extending therefrom. In some embodiments, the first and/or second handle 74, 76 may be operably coupled or integrally formed with the first and/or second shaft 78, 80. In some examples, the first handle 74 includes a central hub 82 and a pair of extensions 86 protruding from opposing sides of the hub 82. Similarly, the second handle 76 also includes a central hub 84 and a pair of extensions 88 protruding from opposing sides of the hub 84. The first and/or second handle 74, 76 may be used to rotate the respective first and/or second shaft 78, 80 by hand and/or with any desired tool. In some examples, the first and/or second handle 74, 76 may be made of a first material, such as a polymeric material, and the first and/or second shaft 78, 80 may be made form a second material, such as a metallic material. In some instances, the first and/or second handle 74, 76 formed from the first material may be over-molded onto the first and/or second shaft 78, 80 of the second material. In other embodiments, the handle and the shaft may be formed from a substantially similar composition. In some examples, the shaft may be non-threaded and include other locking features such as a hole through which a cotter pin is inserted, and/or through any other lock assembly.

In some embodiments, a tip portion 90 of the first shaft 78 may include a third material, which may be different from the first and second materials of the first locking knob 70. Likewise, a tip portion 92 of the second shaft 80 may also include the third material, which may be different from the first and second materials of the second locking knob 72. For example, the third material is at least partially formed of a nylon material, or other material having some elasticity. Additionally or alternatively, the third material may have a desired frictional coefficient that is greater than that of the second material. The third material may be configured to contact the boom arm 28 and/or the support 18 without substantially scratching and/or otherwise marking the boom arm 28 and/or the support 18 when in contact therewith.

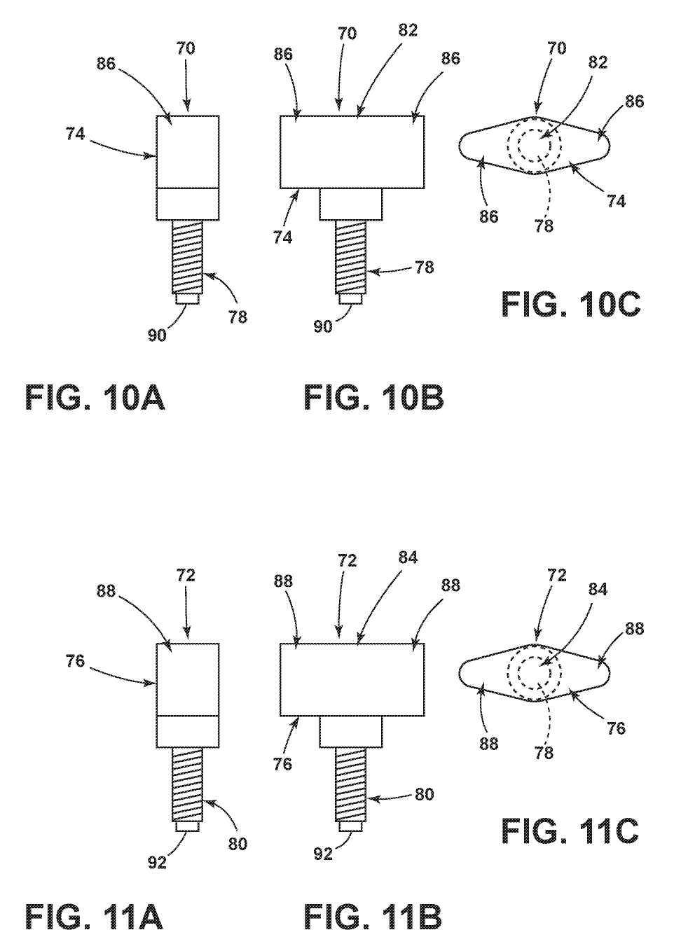

In some embodiments, such as the example illustrated in FIGS. 10A-11C, the first and/or second handle 76 may include a first portion having a first longitudinal width and a second portion having a second longitudinal width. The second portion may be disposed between the first portion and the distal end portion of the first and/or second shaft 78, 80 in a latitudinal direction. The wider first portion may be utilized for rotating the first and/or second shaft 78, 80 to engage and release the first and/or second shaft 78, 80 from the boom arm 28, the support 18, and/or the first and second mounting fixtures 96, 98.

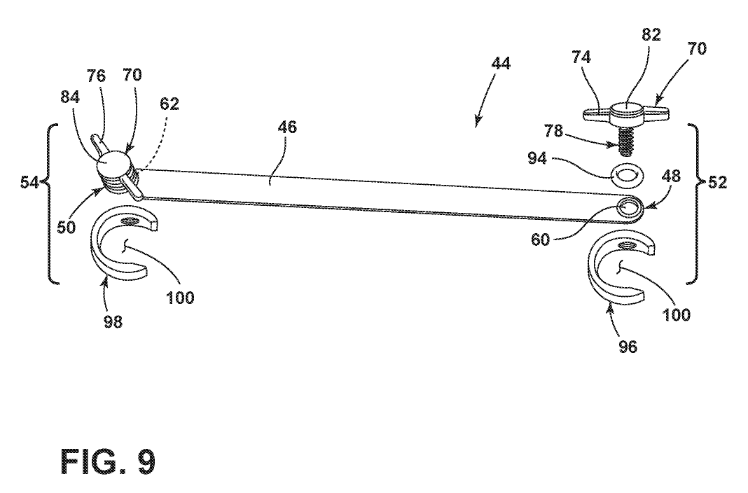

As illustrated in FIGS. 8 and 9, one or more washers 94 may be positioned around the first and/or second shaft 78, 80 such that the washers 94 are disposed between the first and/or second handle 74, 76 and the support member 46 when the first and/or second shaft 78, 80 is positioned through the first and/or second void 60, 62. The number of washers 94 positioned about the first and/or second shaft 78, 80 may be dependent on the width or radius of the boom arm 28 and/or the support 18. The washers 94 may be formed of any material, including any polymeric material, elastomeric material, metallic material, and/or combinations thereof. In some examples, a first number of washers may be positioned around the first shaft while a second, different number of washers may be positioned around the second shaft.

In some embodiments, the mounting fixtures may be disposed on an opposing side of the support member from the handle. For example, in the embodiment illustrated in FIGS. 8 and 9, the first and second mounting fixtures 96, 98 are configured as c-shaped mounting fixtures that are configured to partially surround the support 18 and the boom arm 28 through first and second retaining pockets 100. However, the mounting fixture may be of any shape that fully or partially surrounds the support and/or the boom arm. In some examples, the shafts of the lock assembly may couple with support and/or boom arm and not include a mounting fixture.

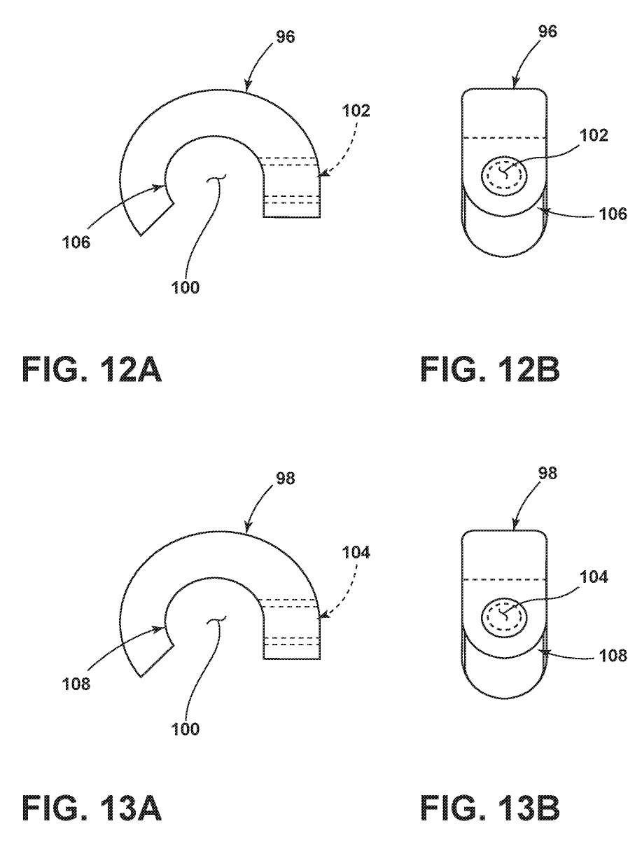

In some embodiments, such as the example illustrated in FIGS. 12A-13B, the first and second mounting fixtures 96, 98 may define respective first and second holes 102, 104 through which the first and second shafts 78, 80 can be respectively positioned. The holes 102, 104 of the first and second mounting fixtures 96, 98 may include threaded portions or be non-threaded. The first and second shafts 78, 80 each include a threaded portion thereon that respectively interact with threaded portions within the first and second holes 102, 104.

The first and second mounting fixtures 96, 98 may also each define a retaining surface 106, 108 on an opposite side of the mounting fixture 96, 98 from the first and second holes 102, 104. In various embodiments, the first and second mounting fixtures 96, 98 may be formed from a metallic material, a polymeric material, an elastomeric material, and/or a combination thereof. In some examples in which the first and second mounting fixtures are formed from a polymeric material, an insert may be disposed within the first and/or second hole. The insert can be formed from a metallic material, such as brass or any other practicable material and may be threaded or unthreaded in various embodiments.

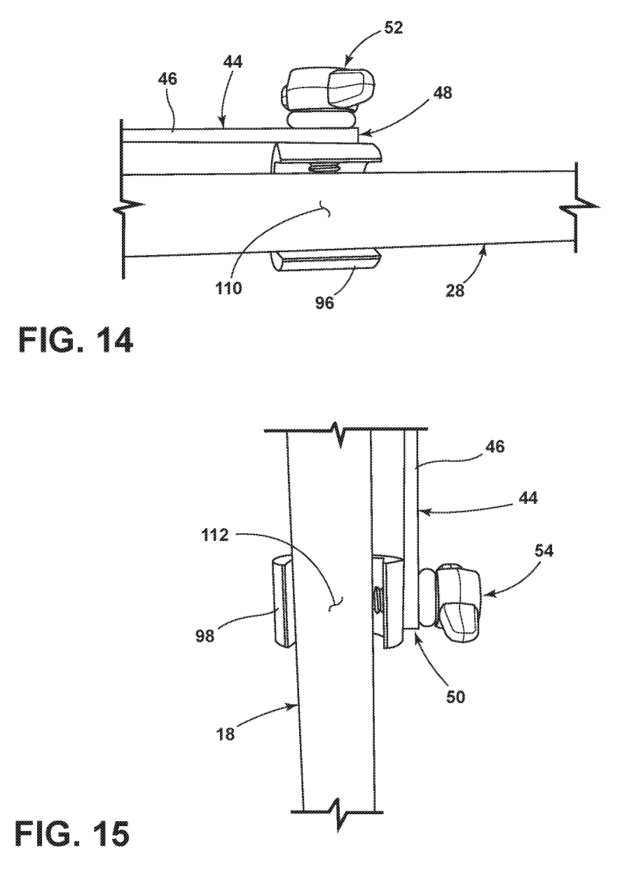

In some embodiments, such as the example illustrated in FIGS. 14 and 15, the first mounting fixture 96 defines an opening 110 that has a width that is greater than the diameter of the boom arm 28. Likewise, the second mounting fixture 98 defines an opening 112 having a width that is greater than the width of the support 18. In other examples, the first and/or second mounting fixture 96, 98 may include a hinge thereon such that the respective mounting fixtures 96, 98 may further surround the support 18 and/or the boom arm 28 in a first, closed position and be removed from the support 18 and/or the boom arm 28 in a second, open position.

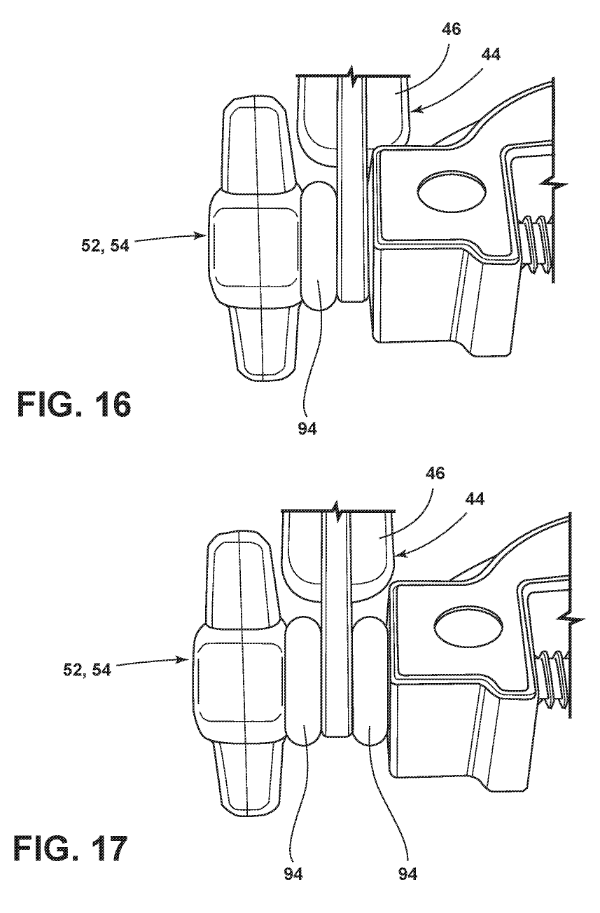

In operation, the first mounting fixture 96 is arranged around the boom arm 28 and the second mounting fixture 98 is arranged around the support 18. The first shaft 78 is disposed through the first void 60 of the support member 46 and inserted into the hole 102 of the first mounting fixture 96. One or more washers 94 can be positioned between the support member 46 and the first handle 74 of the first locking knob 70, as illustrated in FIGS. 16 and 17, to account for variously sized boom arms 28. Once the first shaft 78 is positioned within the hole 102 of the first mounting fixture 96, the first shaft 78 is moved to a position in which the tip portion 90 of the first shaft 78 is in contact with the boom arm 28. Initially, the first shaft 78 may be in loose contact with the support such that the position of the first mounting fixture 96 may be slid along the boom arm 28. Likewise, the second shaft 80 may be disposed through the second void 62 of the support member 46 and into the hole 104 defined by the second mounting fixture 98 until the tip portion 92 of the second shaft 80 is in contact with the support 18. The second shaft 80 may loosely contact the support 18 such that the second mounting fixture 98 may be slid along the support 18. One or more washers 94 can be positioned between the support member 46 and the handle 76 of the second locking knob 72 to account for variously sized supports 18.

With both the first and second mounting fixtures 96, 98 loosely attached, the boom arm 28 can be adjusted relative to the support 18 by repositioning one or both of the first and second mounting fixtures 96, 98 along the boom arm 28 and the support 18, respectively, until a desired boom angle for the particular situation is achieved. The boom arm 28 is then locked into place by tightening the first locking knob 70 by further extending the first shaft 78 towards the boom arm 28 such that the boom arm 28 is compressively retained between the first shaft 78 and the retaining surface 106 of the first mounting fixture 96. The support 18 is compressively retained between the second shaft 80 and the retaining surface 108 of the second mounting fixture 98 once tightened. In addition, the tightening of the first and second shafts 78, 80 into the respective first and second mounting fixtures 96, 98 may also prevent inadvertent removal of the boom arm 28 and/or the support 18 from the retaining pockets 100.

Use of the present disclosure may offer a variety of advantages, which is provided by various combinations of the features provided herein. For instance, the lock assembly provided herein may substantially prevent a microphone boom arm from sagging through quick and simple operation. Moreover, the lock assembly is fully adjustable and can be used on a wide array of microphone stands having various structural configurations. The lock assembly can protect microphones, or any other equipment, that is supported by the microphone stand. In addition, by maintaining the microphone in a desired position, the lock assembly can also prevent ruined recording sessions due to movement of the microphone, or other electronic equipment. The lock assembly may be manufactured at reduced costs compared to other devices and supports that may be commercially available.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate support members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

It is also important to note that the construction and arrangement of the elements of the invention as shown in the examples are illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or support members or connectors or other elements of the system may be varied, the nature or number of adjustment positions provided between the elements may be varied. It should be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting. In addition, variations and modifications can be made on the aforementioned structures and methods without departing from the concepts of the present invention and such concepts are intended to be covered by the following claims unless these claims by their language expressly state otherwise.

What is claimed is:

1. A lock assembly for a stand assembly having a supporting a boom arm, the lock assembly comprising:
a support member defining first and second voids at opposing end portions of thereof;
a first locking knob having a first handle and a first shaft extending from the first handle;
a second locking knob having a second handle and a second shaft extending from the second handle;
a first mounting fixture configured to at least partially surround the boom arm and defining a first hole, wherein the first shaft is positioned through the first void and the first hole; and
a second mounting fixture configured to at least partially surround the support and defining a second hole, wherein the second shaft is positioned through the second void and the second hole.

2. The lock assembly of claim 1, wherein the first and second shafts each define threaded portions thereon that are configured to interact with threaded portions on the first and second holes.

3. The lock assembly of claim 1, further comprising:
a first tip portion on the first shaft; and
a second tip portion on the second shaft, wherein the first and second shafts are formed from a first material and the first and second tip portions are formed from a second, different material.

4. The lock assembly of claim 3, wherein the second material has a higher coefficient of friction than the first material.

5. The lock assembly of claim 1, further comprising:
a first insert disposed within the hole of the first mounting fixture.

6. The lock assembly of claim 1, further comprising:
a rib extending between the first and second voids of the support member.

7. The lock assembly of claim 1, further comprising:
one or more washers positioned around the first shaft on an opposing side of the support member from the first mounting fixture.

8. The lock assembly of claim 1, wherein the first handle is over-molded onto the first shaft.

9. The lock assembly of claim 7, wherein the boom arm is configured to be compressively retained between a retaining surface of the first mounting fixture and the first shaft.

10. A lock assembly, comprising:
a support member defining first and second voids;
a first locking knob having a first shaft;
a second locking knob having a second shaft;
a first mounting fixture defining a first hole and a first retaining pocket, wherein the first retaining pocket is configured to at least partially surround a boom arm; and
a second mounting fixture defining a second hole and a second retaining pocket, wherein the second retaining pocket is configured to at least partially surround a support.

11. The lock assembly of claim 10, further comprising:
a first washer positioned around the first shaft; and
a second washer positioned around the second shaft.

12. The lock assembly of claim 11, wherein the first locking knob further includes a first handle and a first tip portion at opposing ends of the first shaft, the first handle formed from a first material, the first shaft formed from a second material, and the first tip portion formed from a third material.

13. The lock assembly of claim 12, wherein the third material is at least partially formed of a nylon material.

14. The lock assembly of claim 10, wherein the first mounting fixture defines a first opening and the second mounting fixture defines a second opening, the first opening having a width that is greater than a diameter of the boom arm and the second opening having a width that is greater than a diameter of the support.

15. The lock assembly of claim 10, wherein the first and second shafts each define thread portions thereon that are configured to interact with threaded portions on the first and second holes.

16. The lock assembly of claim 10, wherein the support is configured to be compressively retained between a retaining surface of the second mounting fixture and the second shaft.

17. A lock assembly, comprising:
a support member defining first and second voids;
a rib extending from the support member;
a first mounting fixture operably coupled with a first shaft, wherein the first mounting fixture is configured to at least partially surround a boom arm; and
a second mounting fixture operably coupled with a second shaft, wherein the second mounting fixture is configured to at least partially surround a support.

18. The lock assembly of claim 17, wherein the rib extends between the first and second voids of the support member.

19. The lock assembly of claim 17, wherein the first shaft is positioned through the first void and the second shaft is positioned through the second void.

20. The lock assembly of claim 17, wherein the first and second shafts each include a threaded portion thereon that respectively interact with threaded portions within first and second holes respectively defined by the first and second mounting fixtures.
